(19) United States
(12) Patent Application Publication
(10) Pub. No.: US 2009/0102622 A1
(43) Pub. Date: Apr. 23, 2009

(54) APPARATUS AND METHOD FOR REMOTE MONITORING AND DEACTIVATION OF AN ASSET

(76) Inventors: Daniel N. Ashman, Montrose (CA); Lynn M. Miner, Chewelah, WA (US); Shaun P. Ashman, N. Mansfield, TX (US); Alain P. Dupere, Calgary (CA); Henry A. Trujillo, Rio Rancho, NM (US); Brian T. Bot, Kelowna (CA); Kevin N. Driedger, Nelson (CA)

Correspondence Address: MOORE & VAN ALLEN PLLC, P.O. BOX 13706, Research Triangle Park, NC, 27709, US

(21) Appl. No.: 12/103,977

(22) Filed: Apr. 16, 2008

Related U.S. Application Data
(60) Provisional application No. 60/981,914, filed on Oct. 23, 2007.

(51) Int. Cl. B60R 25/10

(52) U.S. Cl. 340/426.12

(57) ABSTRACT

There is disclosed an apparatus for remotely and controllably deactivating or partly deactivating a first asset, which first asset may comprise an air dependent power source. The apparatus may comprise a regulator associated with the first asset. The regulator may comprise a valve having first and second positions and the first position may allow a first rate of the air supply to the power source and the second position may allow a second rate of air supply to the power source and the second rate may be less than the first rate. The apparatus may further comprise a controller remote from the regulator for transmitting a control signal to the regulator; the valve being actuable in response to the control signal to move between the first and second positions thereby regulating the air supply to the power source.

### CROSS-REFERENCES

This application is related to U.S. provisional application No. 60/981,914, filed Oct. 23, 2007, entitled “Apparatus and Method for Remote Monitoring and Deactivation of an Asset”, naming Daniel Ashman et al. as inventors. The contents of the provisional application are incorporated here by reference in their entirety, and the benefit of the filing date of the provisional application is hereby claimed for all purposes that are legally served by such claim for the benefit of the filing date.

### BACKGROUND

There are a number of methods commercially available that are used for remote monitoring and tracking of assets. WO99/43513, Ligoci and Goletas, published Sep. 2, 1999 discloses a vehicle disabling system; U.S. Pat. No. 6,042,678 to Muise & Thomas, issued Jun. 6, 2000 discloses a vehicle disabling system for use by pursuing law enforcement officials; U.S. Pat. No. 531,851, to Wright, issued May 17, 1994 discloses a Methane Monitor and Engine Shutdown System.

### SUMMARY

This application relates to a method and apparatus for remotely and controllably deactivating or partly deactivating an asset.

In a first embodiment, there is disclosed an apparatus for remotely and controllably deactivating or partly deactivating a first asset; the first asset may comprise an air dependent power source having an air supply and the apparatus comprising: a regulator associated with the first asset and comprising a valve having first and second positions wherein the first position allows a first rate of the air supply to the power source and the second position allows a second rate of the air supply to the power source and wherein the second rate may be less than the first rate; and a controller remote from the regulator, for transmitting a control signal to the regulator; the valve being actuable in response to the control signal to move between the first and second positions thereby regulating the air supply to the power source.

In alternative embodiments, the controller may be comprised in a control center and the regulator may comprise a transmitter for transmitting asset status information to the control center.

In alternative embodiments, the valve may have a plurality of alternate positions between the first and second positions and may be actuable to adopt successive positions to incrementally regulate the air supply.

In alternative embodiments, the apparatus may comprise a second controller and the valve may be actuable in response to a signal from the second controller to move into a selected position to at least partly limit the air supply to the power source.

In alternative embodiments, the first controller may also transmit a permission signal to the regulator and the movement of the valve into one of the positions may be reversible in response to the permission signal from the first controller.

In alternative embodiments, the apparatus may further comprise a plurality of the assets and wherein the individual ones of the assets may be independently remotely and controllably deactivateable or partly deactivateable.

In alternative embodiments, the valve may have an associated valve position sensor and the status information may include information regarding the valve positions.

In alternative embodiments, the regulator may comprise a hydrocarbon detector and may be adapted to deactivate the power source when information from the sniffer satisfies predetermined parameters.

In alternative embodiments, the asset status information may comprise asset positional information.

In alternative embodiments, the asset may be a motor vehicle.

In alternative embodiments, the asset may be a commercial vehicle and the regulator may comprise a substantially tamper proof housing.

In alternative embodiments, the asset status information may be selected from the group consisting of: the make and model of the asset; the owner of the asset; the place of registration of the asset; insurance information about the asset; and the attachment of any trailer to the asset.

In alternative embodiments, at least one of the control signal and the permission signal may be encrypted.

In alternative embodiments, there is disclosed a method for remotely and controllably deactivating or partly deactivating a first asset; the first asset comprising an air dependent power source having an air supply and the method comprising providing a regulator associated with the first asset and comprising a valve having first and second positions wherein the first position allows a first rate of the air supply to the power source and the second position allows a second rate of the air supply to the power source and wherein the second rate may be less than the first rate and providing a controller remote from the regulator, for transmitting a control signal to the regulator; the valve being actuable in response to the control signal to move between the first and second positions thereby regulating the air supply to the power source.

In alternative embodiments, the method may comprise providing a second controller and the valve may have a plurality of positions between the first and second positions and may be actuable in response to a signal from the second controller to move into a selected one of the positions to at least partly limit the air supply to the power source.

In alternative embodiments, the partial limiting of the air supply may be substantially complete.

In alternative embodiments, the regulator may comprise a hydrocarbon detector and may be adapted to deactivate the power source when information from the hydrocarbon detector satisfies predetermined parameters.

In alternative embodiments, there is disclosed an apparatus for controllably deactivating, or partly deactivating, a first asset, in response to a control signal from a remote controller, the first asset comprising an air dependent power source having an air supply and the apparatus comprising: a regulator associated with the first asset and comprising a valve having first and second positions wherein the first position allows a first rate of the air supply to the power source and the second position allows a second rate of the air supply to the power source and wherein the second rate may be less than the first rate; and the valve may be actuable by the regulator in response to a control signal from the controller to move between the first and second positions so that the apparatus may be useable to deactivate or partly deactivate the asset in response to the control signal.

In alternative embodiments, the apparatus may comprise a transmitter for transmitting asset status information to the control center.

In alternative embodiments, the valve may have a plurality of alternative positions between the first and second positions and may be actuable in response to a signal from the controller to adopt successive ones of the positions to incrementally regulate the air supply.

In alternative embodiments, the apparatus may comprise a second controller and the valve may be actuable in response to a signal from the second controller to move into a selected position to at least partly limit the air supply to the power source.

In alternative embodiments, the regulator may comprise a hydrocarbon detector and may be adapted to deactivate the power source when information from the hydrocarbon detector satisfies predetermined parameters.

In alternative embodiments, the asset may be a motor vehicle.

In alternative embodiments, the asset may be a commercial vehicle and the regulator may comprise a substantially tamper proof housing.

Features and advantages of the subject matter disclosed will become more apparent in light of the following detailed description of some embodiments thereof, as illustrated in the accompanying figures. As will be realized, the various embodiments are capable of modifications in various respects and may be combined in a variety of alternative ways, all without departing from the spirit and scope of the claims. Accordingly, the drawings and the description are to be regarded as illustrative in nature, and not as restrictive.

### BRIEF DESCRIPTION OF DRAWINGS

FIG. 1 Is a representation of a system of a first embodiment.

FIG. 2 Is an installation according to a first embodiment.

FIG. 3 Shows screen display of an embodiment.

FIG. 4 Is a bottom view of an installed valve and a valve controller according to an embodiment.

FIG. 5 Is a cross sectional end view of an installed valve and a valve controller according to FIG. 4.

FIG. 6 Is a top view of a valve controller according to FIG. 4 with any lid removed.

FIG. 7 Is a side cross sectional view of FIG. 5.

FIGS. 8A and 8B Show a valve controller in two alternative positions.

FIG. 9A Is a cross sectional view of a valve in a closed position.

FIG. 9B Is a cross-sectional view of a valve in a partly open position.

FIG. 9C Is a cross-sectional view of a valve in an open position.

FIG. 10 Is a system diagram according to an embodiment.

FIG. 11 Is a representation of a system according to an embodiment.

### DESCRIPTION

In this disclosure “air” means atmospheric air, or any oxygen containing gas or liquid which may be reactible with a fuel. In embodiments air may be or may comprise atmospheric air or oxygen or may be a mixture of gases comprising air or oxygen and may be compressed or may be at atmospheric pressure or may be provided under any conditions of temperature or pressure.

In this disclosure “air dependent” means with respect to a power source that the power source requires a supply of air (as defined herein) for reaction with a fuel.

In this disclosure “air supply” means the supply of air to a power source and includes any form of provision for access of a power source to a supply of air, as defined herein. As the context requires, it may comprise the air or other gas or liquid supplied to the power source or may indicate the apparatus whose function includes guiding such air to the power source for use thereby. An air supply may be directly drawn from atmospheric air or may comprise stock gas or liquid associated with an asset. By way of example and not limitation, it may include bottled and/or compressed oxygen or mixtures comprising oxygen. For greater certainty, the specification that a power source has an air supply, means that the power source comprises or has associated therewith apparatus for channelling air to the power source, or has access to a source of air and does not mean or imply that the power source is fed with air at all times.

In this disclosure “asset” means any possession or article having a power source. In alternative embodiments and with suitable adjustments it may include without limitation, any type of vehicle including boats, ships, cars, trucks, trains, commercial and domestic vehicles, and hovercrafts. In alternative embodiments assets may or may not be mobile and may include diesel systems, generators, drilling apparatuses, bulldozers, graders, haulers, rollers, cranes, backhoes and other types of equipment which may be for use in the construction industry or in the hydrocarbon industry. It will be understood by those skilled in the art that some embodiments may be unsuitable for use in some types of assets or in some circumstances. Those skilled in the art will be easily able to determine how and when to implement particular embodiments. In some embodiments an asset may include a trailer or other attachment.

In this disclosure “asset status information” means any information regarding the status of an asset or its environment and may include information on power source status, position, speed, velocity, time, fuel reserves, engine activity, rpm, temperature, wind or other physical or environmental parameters. It may also include historical data on any such parameters and may include information regarding other matters such as ownership, insurance, registration, licensing, maintenance history, upcoming maintenance requirements, fault conditions and model of the asset. In embodiments asset status information may also comprise information on any trailer or other attachment to the asset including whether such trailer of other attachment is in place or is disconnected.

In this disclosure “deactivate” has its ordinary meaning and in certain embodiments may include partial and complete deactivation, disabling, shutting down, immobilising or down regulation. By way of example and not of limitation, where the power source is an engine, deactivation may comprise reducing or eliminating the rpm (revolutions per minute) or power output of the engine and may be gradual or rapid or immediate and may be reversible. The choice of the most desirable levels of deactivation in given circumstances will be easily made by those skilled in the art. Deactivating may comprise ending or substantially ending or limiting or partly limiting the power output from the power supply and where the asset is mobile then deactivation may include immobilising the asset.

In this disclosure, “fuel” has its ordinary meaning and without limiting the foregoing, fuels may be or may comprise liquid, solid or gaseous fuels, hydrocarbons, diesel, petroleum, kerosene, paraffin, natural gas, coal gas, propane, butane, methane, alcohols, hydrogen, and any artificially, naturally or biologically derived fuels.

In this disclosure, “including” has its ordinary meaning but for greater certainty includes comprising, not limited to, not excluding other possible ingredients, components or possibilities. The statement that a state of affairs includes a specified component means that the specified state of affairs optionally may, but need not necessarily, include other unspecified components.

In this disclosure “or” is to be understood inclusively and not exclusively unless clearly inconsistent with the context. For further certainty a phrase listing the possibility of a first “or” second state of affairs is to be understood to include, contemplate, and allow either state of affairs existing alone and also to contemplate, include and allow the simultaneous existence of both states of affairs.

In this disclosure, an “overspeed” condition means a condition where the speed or rpm of an engine or other power source exceeds its allowable recommended upper limit (which may also be referred to as the “Red Line” on the tachometer). Without limiting the foregoing, “overspeed” may include any situation where the speed of functioning or output of the power source reaches a point that causes or may cause physical damage to the power source or may cause the power source to self destruct or explode. It will be understood by those skilled in the art that while commercial vehicles may have a governor or equivalent installed to prevent overspeed by limiting the fuel supplied to the fuel injectors, in a hydrocarbon rich environment, a governor may not prevent an overspeed condition because for instance in some situations a useable fuel may enter the system via the air supply.

In this disclosure, “position”, where used in reference to a valve, means and includes its state, condition, configuration, disposition or status and by way of illustration and not limitation, a closed or partly closed position may indicate a configuration wherein a valve substantially prevents or limits the flow of air therethrough, and an open position may indicate a configuration wherein a valve does not limit or only partially limits the flow of air therethrough.

In this disclosure “power source” means any device for generating power by the combustion of a fuel. In alternative embodiments a power source may be or may comprise a combustion engine which may be an internal combustion engine, a diesel engine or a petrol engine or a gas engine. In certain embodiments a power source may include hybrid power sources, for example power sources that may be combinations of or alternate power sources or fuels, such as a combination of electricity and fuels.

In this disclosure, “remote” or “remotely” has its normal meaning and includes such spatial relationships as apart, distant, separated, operating or controlled from a distance. Without limiting the generality of the foregoing, with respect to an asset and communication with the asset, “remote” indicates that the asset is or may be separated from the controller and that communication with the asset must occur at a distance, or may occur with no hard connection between the controller and the asset, and may occur wirelessly through a cellular network, a satellite network, a bluetooth network or any other suitable means of remote communication, all of which will be readily identified and implemented by those skilled in the art.

In this disclosure, “trailer” has its ordinary meaning but for greater certainty includes any type of van, wagon, or carrying or enclosing device drawn, pulled, pushed, carried, borne, or otherwise moved by an asset. In particular embodiments, a trailer may be a device used for hauling freight by road or rail or may be used as a mobile home or place of business or control center or for any other purpose. In certain embodiments a trailer may be comprised in or associated with an asset.

In this disclosure, “transmit” and “transmitting” means to transmit, send, forward, convey, or dispatch any form of communication signal and in certain embodiments, it may include transmission by wire, or wirelessly, including through a cellular or satellite or bluetooth network.

In this disclosure, “valve” means and includes any device for halting or controlling or regulating the flow of a liquid, gas, or other material through a passage, pipe, tube, inlet, outlet, or conduit of any kind. In particular embodiments, a valve may include any form of cock, faucet, flap, gate, hydrant, lid, pipe, plug, shutoff, spigot, stopper, tap or other flow regulating device or structure and may include butterfly valves, gate valves and any other valve types.

In this disclosure “valve controller” means an assembly for controlling a valve, and may be or may comprise or be associated with a valve, and in certain embodiments may contain a microprocessor or a motor or equivalent device or function for adjusting or controlling a valve or part thereof.

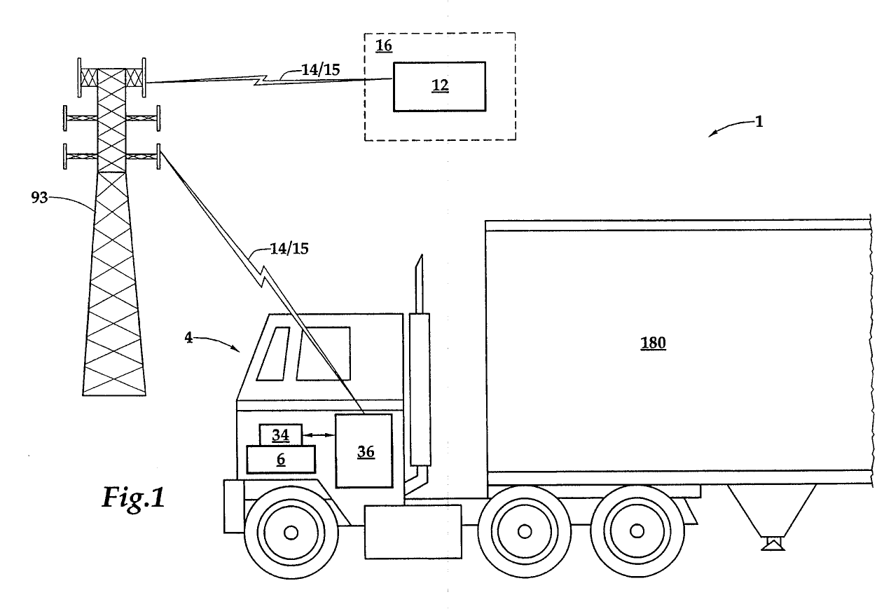

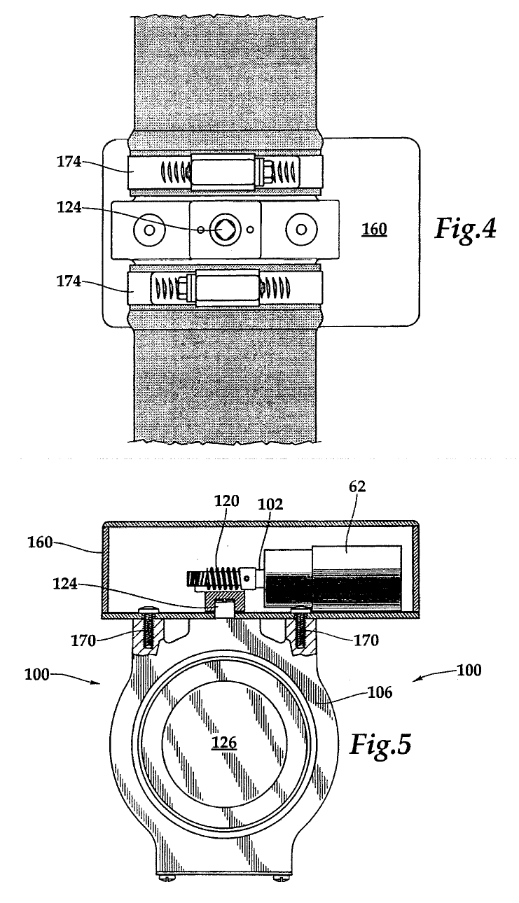

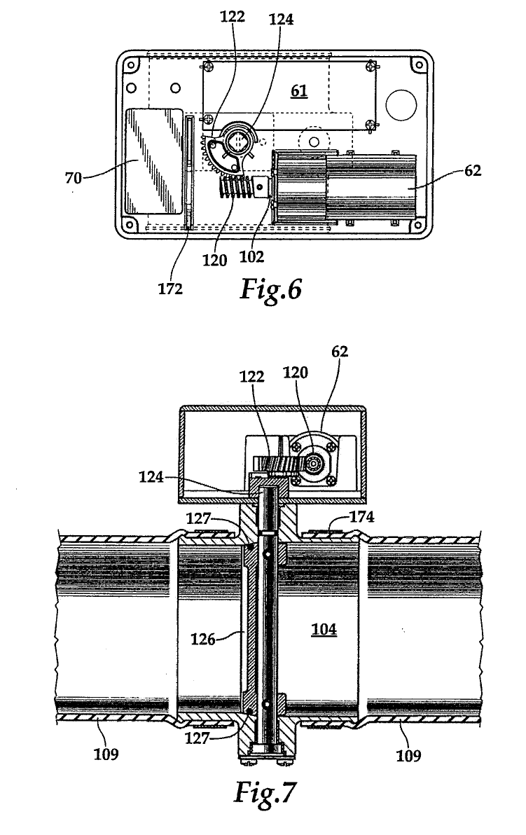

A first embodiment of the system, apparatus and method claimed is generally designated 1 and is described with reference to FIGS. 1 through 11. The embodiment comprises apparatus for remotely and controllably deactivating or partly deactivating a first asset 4, which may be a domestic or commercial vehicle and may be a truck and may comprise or be associated with a trailer 180. The first asset 4 may comprise an air dependent power source 6 having an air supply. The apparatus may comprise a regulator 8 associated with a first asset 4 and comprising a valve 10 having first and second positions. The first position may allow a first rate of air supply to the power source 6 and the second position may allow a second rate of air supply to the power source 6. In embodiments the second rate may be less than the first rate. The apparatus may also comprise a controller 12 remote from the regulator 8, for transmitting a control signal 14 to the regulator 8. In embodiments the valve 10 may be actuable in response to a control signal 14 to move between first and second positions thereby regulating the air supply to the power source 6. In alternative embodiments the controller 12 may be comprised in or may comprise a control center 16, and the regulator 8 may comprise a transmitter or receiver or transmitter receiver, all of which is generally designated 20. In embodiments the transmitter 20 may transmit asset status information 15 to the control center 16 or to controller 12 which may be comprised in or associated with control center 16. In embodiments the control center 16 may be or may comprise or may be associated with a fleet operations center and may be mobile or may operate through a distributed or other network and may operate through the internet. The regulator 8 and particularly valve controller 34 may comprise a substantially tamper proof housing 160 to protect one or more parts thereof.

In embodiments, valve 10 may have a plurality of alternate positions between the first and second positions and may be actuable to adopt successive positions to incrementally regulate the air supply to power source 6. In alternative embodiments, the apparatus may comprise a second controller 22, which may be or may comprise an emergency stop switch 24 and the valve 10 may be actuable in response to a signal from the second controller 22 to move into a selected position to at least partly limit the air supply to the power source 6. In embodiments, the second controller 22 may actuate a substantially complete shutdown of the air supply to power source 6 by causing the adoption of a suitable valve position. In certain embodiments, the first controller 12 may also be suitable to transmit a permission signal to the regulator 8 and the movement of valve 10 into one of the positions may be reversible in response to, or following receipt by regulator 8 of, a permission signal from the first controller 12. In certain embodiments the asset may be configured so that following a shutdown by the second controller 22, it cannot be reactivated until reset by a suitable permission signal. It will be understood that such permission signal may be comprised within the term “control signal” as used herein. In embodiments, the system, method and apparatus may comprise a plurality of assets and individual assets may be independently remotely and controllably deactivateable or partly deactivateable. In embodiments the valve 10 may have an associated or integral valve position sensor 28 and the status information 15 may include information regarding the position of valve 10.

In greater detail and in particular embodiments, the regulator 8 may comprise a valve controller 34 closely associated with the power source 6 or the air supply thereto and a monitor 36 which may be, or may comprise, an in cab controller, and may be connected to regulator 8 by a cable 40 which may pass through a firewall. In embodiments, cable 40 may be replaced by wireless communication in ways that will be readily understood by those skilled in the art. In embodiments, monitor 36 or a part thereof, may be positioned in the cab of the asset 4.

Monitor 36 may comprise a first microprocessor 42, connected to a cellular modem 44 by connection 43 and may comprise a cellular or satellite or other transceiver 20 and may comprise a GPS receiver 46. In embodiments, GPS positioning may be used to track mobile assets and in embodiments a suitable GPS transceiver unit may be an A1080-A Full NMEA™ GPS Unit from Tyco™ Electronics or Falcom/RMT™ or an Enfora™ modem but a range of suitable alternatives will be readily apparent to those skilled in the art. In an embodiment, the GPS receiver 46 may be integral to the modem 44. In an embodiment, a cell phone transmitter/receiver with its antenna 20 may be integral to the modem 44. Microprocessor 42 may also have an earth 50 to the chassis of the asset 4; and may have a source of power 52 which may be a 12V DC power supply and may be connected to first microprocessor 42 by a connection 53. The monitor 36 may also be directly connected to a dashboard status indicator 54, which may be an LED, by a cable 58 and may be connected to and actuable by second controller 22 which may be or may comprise an emergency stop switch 24, through an emergency stop cable 60. In embodiments an RPM sensor 32 may also feed information to monitor 36 through a connection 37. In embodiments a further connection 39 may be provided to a CAN Bus monitoring device 41 which may serve to integrate response to a variety of danger signals or information inputs from the power source 6 or other sources. In embodiments, the CAN Bus device may be a J1939\J1587. It will be understood that in embodiments power may also or alternatively be fed to valve controller 34 from power source 52 through regulator/monitor connection 40.

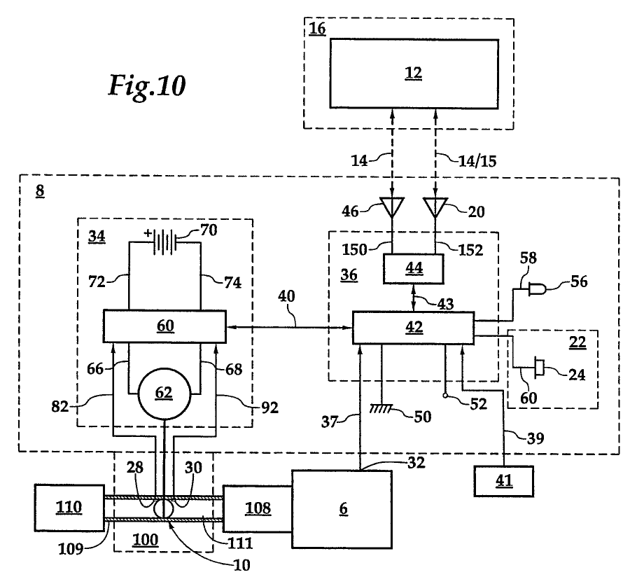

The regulator 8 may comprise a valve controller 34, which may comprise a second microprocessor 60 and a valve motor 62, which may be a brushless DC motor and may be controlled by a second microprocessor 60 through connections 66 and/or 68. The valve controller 34 may also contain a backup power supply 70 which may be or may comprise a battery, and in embodiments may comprise a combination of 9V DC batteries. In embodiments a backup power supply 70 may generate a 12V or other DC power supply and may be connected to second microprocessor 60 through connections 72 and/or 74. Second microprocessor 60 may be mounted on, or valve controller 34 may otherwise comprise, a valve controller circuit board 61. The second microprocessor 60 may also receive inputs from a temperature sensor which may be integral to the valve 10, and from a valve position sensor 28 through connection 82. It will be understood that while shown diagrammatically in FIG. 10, in embodiments the temperature sensor 10 may be integral to the second microprocessor 60 and that the valve position sensor 28 may be comprised in the worm gear assembly and operate through sensors provided in the controller and in embodiments on the microprocessor 60. In embodiments the monitor 36 through controller 34 and microprocessors 42 and 60 may also receive information from a hydrocarbon sensor or sniffer 30 through connection 92. Valve controller 34 may comprise or be contained in a tamper-proof housing 160. In particular embodiments the microprocessors of the invention may be off the shelf units from FreescaleSemiconductor™ in which case microprocessor 42 of the monitor may be part number MC9S08AW60 and valve controller microprocessor 60 may be part number MC9S08AW60. It will be understood that in embodiments some or all of the connections between microprocessors and sensors and microprocessors or sensors themselves, may be embedded in other devices or connections. By way of example and not of limitation, the connections between the valve controller microprocessor 60 and any hydrocarbon detector, temperature monitor, valve position monitor, airflow monitor or the like may be embedded in the microprocessor 60 and/or the other connections between the valve controller 34 or microprocessor 60 and the valve 10 or valve motor 62. Sensor connections and other connections to monitor 36 or parts thereof may similarly be embedded in other existing connections or structures.

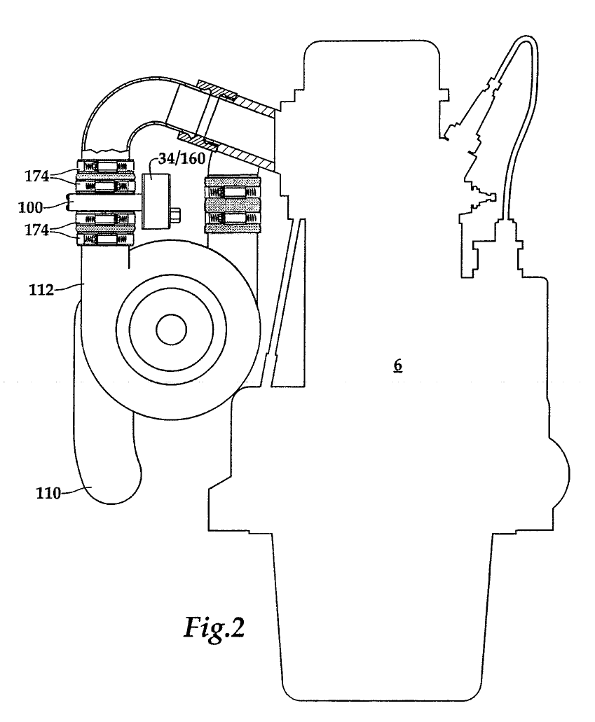

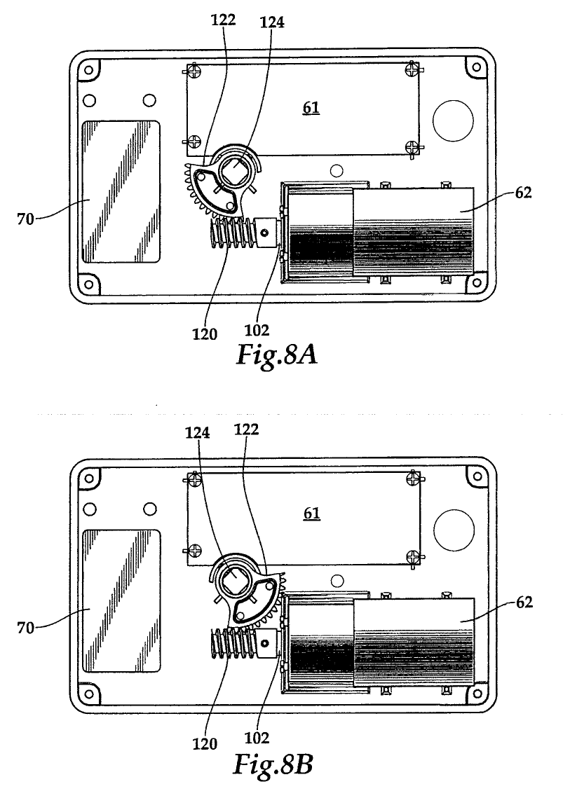

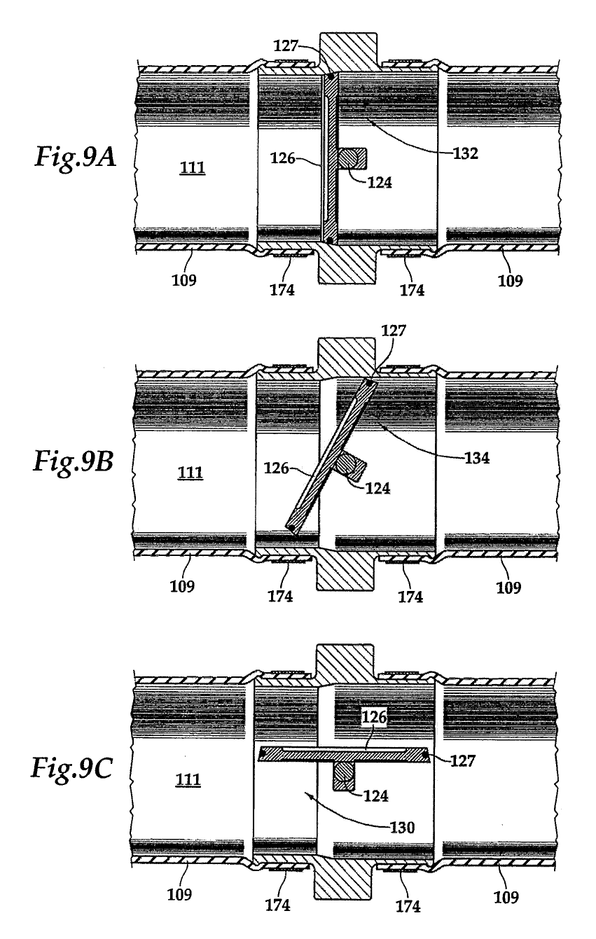

Valve controller 34 may comprise or may be associated with a valve assembly 100, comprising valve 10 and drive shaft 102 driven by valve motor 62. Valve 10 may be positioned to control the air supply to the power source 6 through the lumen 111 of pipe or other conduit 109. In the illustrated but non-limiting embodiment of FIG. 10 the air supply flows through an air intake 110, through pipe 109, to intake manifold 108 and thence is used by engine 6. With particular reference to FIG. 2 the apparatus may comprise an air intake 110 and may comprise an air filter, and may also comprise a turbocharger 112. In response to signals from microprocessor 60 valve motor 62 may rotate drive shaft 102, rotating worm 120 to move worm gear 122, and thus rotating shaft 124 of valve 10 to thereby rotate valve flap 126, with peripheral gasket 127, to adopt a desired configuration. FIGS. 8A and 8B show the movement of worm gear 122 to position valve flap 126 in different positions by rotating shaft 124. FIG. 9 illustrates three possible positions for valve flap 126 in cross section. When valve 10 is in a first position 130 which may be completely open, flap 126 may minimally obstruct air supply through pipe 109 as shown in FIG. 9C. In a second or closed position 132 shown in FIG. 9A the flap 126 may completely block flow of air through pipe 109. In a further position 134 the flap 126 partly limits airflow through pipe 109. In alternative embodiments the valve may also be a gate valve and may be driven by a rack and pinion system in ways that will be readily apparent to those skilled in the art.

In embodiments, components for use in the apparatus may be selected to be able to operate over a temperature range of from about −40° C. up to about +160° C. In alternative embodiments tolerance of temperature ranges extending below about −40° C. or above about +150° C. or between about −40° C. to −20° C.; −20° C. to 0° C.; 0° C. to 20° C.; 20° C. to 40° C.; 40° C. to 60° C.; 60° C. to 80° C.; 80° C. to 100° C.; 120° C. to 14° C. or 14° C. to 160° C. may be selected.

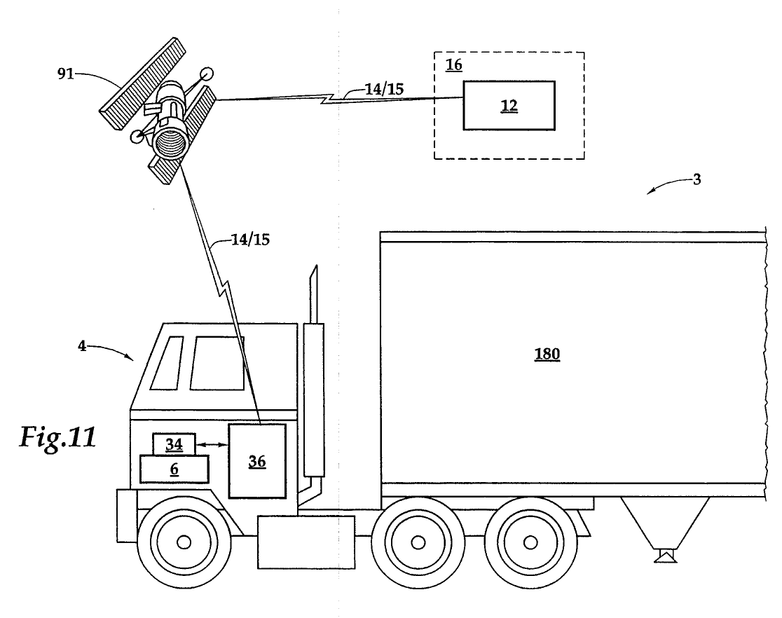

As will be seen from FIGS. 1 and 11 in broad aspect, control signals 14, which may include permission signals, may be transmitted from the controller 12 of control center 16 to the asset 4 and information signals 15 may be transmitted from asset 4 to controller 12 of control center 16. Such transmission may occur through the medium of a conventional cellular network 93 as shown in FIG. 1, or through a satellite system 91 as shown in embodiment 3 of FIG. 11, or through any other suitable remote communications system, many of which will be readily apparent to and understood by those skilled in the art. A control signal 14 may be received by monitor 36, which passes suitable instructions to valve controller 34 which actuates the valve 10. At the asset 4, the regulator 8 comprising monitor 36 and valve controller 34 may gather information from the various sensors provided for this purpose and may transmit the information to controller 12. In embodiments, some or all of the signals between the regulator 8 and the controller 12 and/or control center 16 may be encrypted in ways that will be readily understood and applied by those skilled in the art.

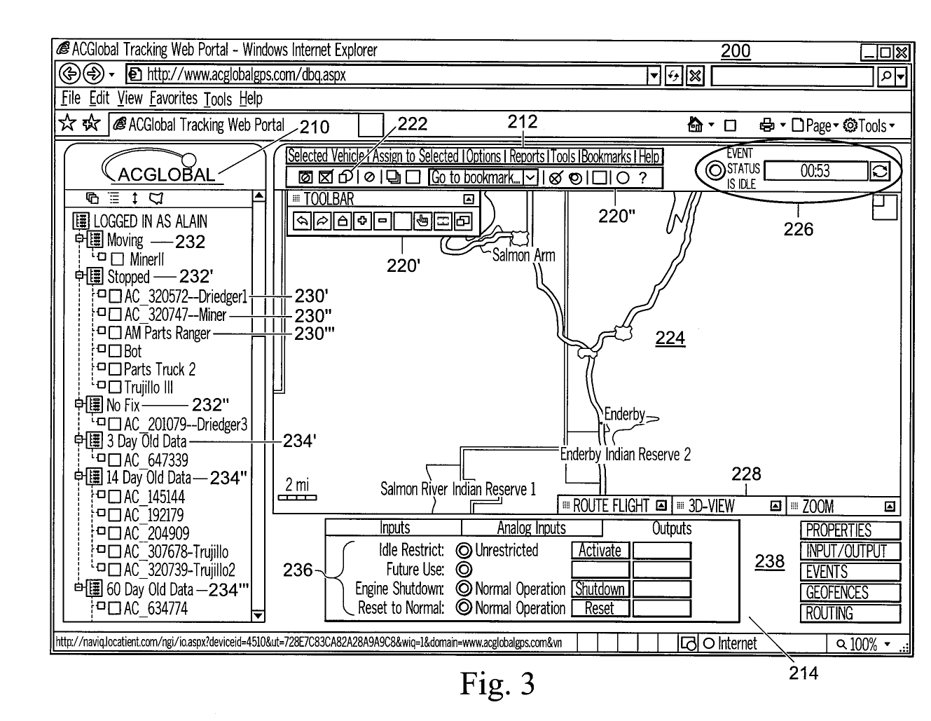

A screen display in a form that may be used in an embodiment is described with reference to FIG. 3. The display is generally designated 200 and in this case is presented through a conventional web browser. A portal display may comprise an asset window 210, a mapping or location window 212 and a control window 214. It will be seen that mapping window 212 contains suitable toolbars 220, including option buttons 222 to select a specific function for monitoring, a map 224 to display the specific location of the selected asset, and a status timer 226. Conventional options to zoom in, present different views and the like may be provided in buttons 228. Status window 210 may list individual asset identities 230, and may categorise these by their motion or other status into groupings 232. Historical data groupings 234 may also be displayed. Control window 214 may comprise actuating buttons 236 to allow a user to actuate particular controls such as engine shutdown and reset, idle restriction and the like. Other actuating buttons 238 may allow the selection of alternate panels of actuating buttons. Those skilled in the art will recognise that a variety of user interfaces and data displays are possible and will readily choose between and implement appropriate types.

In the event of an unauthorized use of the asset 4 or any other suitable trigger event which may be determined by the user, the controller 12 may trigger deactivation of the power source 6 and hence of the asset 4. In this case, the controller 12 transmits a suitable control signal to the regulator 8 (which may comprise monitor 36 and valve controller 34) which actuates the desired change in state of the valve 10 to cause the valve 10 to adopt a desired position or sequence of positions. Data regarding the progress of the deactivation process may then be transmitted back to the controller 12. Confirmation of deactivation may also be confirmed via the monitoring functions of the monitor 36 by determining position, speed time or other asset status information. Where a backup power source 70 is provided or in other embodiments, then if the primary power supply (which may be provided by power source 6) to the regulator 8 is interrupted then the apparatus may be configured to automatically reduce the air supply through the air conduit to deactivate the power source 6. Similarly the regulator 8 may be configured so that automatic deactivation or partial deactivation is automatically initiated by any tampering with the regulator 8 or asset 4. This may be implemented in a range of ways that will all be readily apparent to and implemented by those skilled in the art and includes but is not limited to the use of anti tamper loops in the various cables and connections used. Other tamper-proof mechanisms such as enclosing part or all of the regulator 8 and/or the valve 10 and its associated components in a tamper-proof housing 160, may be employed to detect sabotage or unauthorized handling as well as techniques to prevent tampering by unauthorized personnel. In one embodiment the valve controller 34 may comprise or be contained in a tamper-proof housing 160. In an embodiment the tamper proof housing 160 may be or may comprise a cast metal enclosure that has its removable cover fastened with tamper resistant security fasteners and “Locktite”™ thread compound applied so that the fastener heads break off preventing unauthorized entry into the unit or part of the unit. Any backup power source 70 may also be located inside the anti-tamper housing. It will be apparent that in an embodiment the valve 10 may be secured to tamper proof housing 160 by bolts 170, screws or other suitable means or in other embodiments may be enclosed or partly enclosed within the tamper proof housing 160. In embodiments the valve 10 may be secured in the air pipe by conventional means such as the use of suitable tube clamps 174.

An emergency stop controller 22 may be useable by an operator or user, such as a driver, of the asset to substantially completely or partially stop the airflow to the power source 6 to thereby deactivate the asset 4 in response to accidents, emergency situations, threatened hijacking or other situations. In embodiments once the asset has been deactivated by an emergency shutdown it may not be reactivatable until a suitable permission signal from the controller 12 has been received to reset the regulator 8.

In certain embodiments the valve 10 may have a plurality of second states which may differ incrementally in the rate of airflow they allow to the power source 6 and in response to signals from the controller 12 or pursuant to internal programming, the regulator 8 may carry out deactivation to a desired extent by causing the valve 10 to adopt a predetermined position or to sequentially adopt ones of such positions so that the power source 6 may be deactivated over a desired period of time or may be only partially deactivated to a desired extent, and may permit partial power output.

In certain embodiments the apparatus may be configured so that the valve 10 does not and cannot close to a 100% shutoff position when controlled by the controller 12. In these embodiments the valve 10 may only be able to close to the point where the engine reaches its idle speed RPM so that the asset 4 cannot be brought to a complete stop. The asset 4 may then still be able to move or function under its own power allowing law enforcement agencies or others to respond to the condition that caused the controller 12 to initiate the deactivation or partial deactivation. In embodiments a manual shutdown option using a second controller 22 may also be provided to provide a 100% closure option to prevent hijacking or hydrocarbon ingestion.

In certain embodiments, communication between different portions of the apparatus may be hard wired, cellular, radio, Bluetooth, or other, depending on the specific portion of the apparatus in question and the requirements of a user. In alternative embodiments the monitor may be comprised within the regulator.

In certain embodiments the monitor 36 may continuously monitor asset status data or may do so intermittently or may do so only in response to interrogation by a control signal 14 from the controller 12. Similarly, the monitor 36 may be able to record and store asset status information. In certain embodiments the monitor 36 may send a signal to the controller 12 only when specified parameters are met. In an illustrative example which is not limiting, the regulator 8 may transmit an alarm to the controller 12 when the power source 6 exceeds a predetermined level of revolutions per minute (rpm), when the temperature exceeds a predetermined value, or when hydrocarbons are detected in the air supply by hydrocarbon detector 30 which may optionally be incorporated into the apparatus. In certain embodiments, a user may cause the controller 12 to interrogate the regulator 8 for asset status data at a chosen time or the controller 12 may initiate such interrogations automatically, at determined times or on determined events. In certain embodiments, the controller 12 and/or control center 16 may display its received data or may receive instructions from, a user in any conventional manner. In embodiments the control center may be accessible or may operate in a web based manner so that a user may log into a web interface to monitor and/or control the asset or assets.

In some embodiments, the apparatus may comprise a self-test procedure which may operate at both low and high temperatures and the unit may record the results of the self tests. In certain embodiments, the apparatus may comprise warning devices (which may include lights, sirens or other devices) to alert an operator of the asset or a user when the regulator 8 implements changes to the asset. In some embodiments, the regulator 8 may incorporate an alarm to notify a user and/or deactivate the asset if any power supply to the regulator is interrupted or may automatically shut down the asset if the power supply to the regulator is interrupted or if the temperature moves outside of a predetermined acceptable range. In certain embodiments the regulator may be self calibrating. Where a self calibrating function is incorporated then the apparatus may use a set up sequence to determine the configuration of the valve 10 that accompanies a predetermined desired level of activation of the power source 6 and this information may be stored by the regulator 8 and be used by the regulator in determining desirable second states of the valve 10 in specific circumstances.

In embodiments the apparatus may include a realtime hydrocarbon gas analyzer 30 (alternatively referred to as a sniffer) as an indicator of hydrocarbon ingestion. This may be used in combination with an RPM sensor 32. The installation procedure may be enhanced in this implementation by having the apparatus “self calibrate” by the microprocessor 60 or 42 sensing the position of the valve 10 during it's transition to an open or closed position. Where used, the RPM sensor may function through a cable mounted to an RPM “pickoff” on the alternator or a sensor mounted on the flywheel or other suitable rotating body associated with the power source 6. These elements may be comprised in an auto-sensing capability requiring no operator input but functioning in response to input from the controller 12 to stop an overspeed condition by closing the valve 10. In this embodiment, when the power source RPM increases beyond a predetermined value or when a sniffer 30 detects significant amounts of hydrocarbons in the atmosphere then the monitor 36 and/or microprocessor 42 may automatically direct the valve controller 34 to close or partly close the valve 10 to prevent the power source continuing to accelerate. In alternative embodiments, the apparatus may also alert an operator of the asset 4, or the controller 12, or both to the developing overspeed condition and either of them may be able to deactivate the asset by sending a suitable control signal or by using the emergency stop switch. In alternative embodiments, a range of alternative parameters may be used to detect developing over speed conditions and RPM and that RMP or hydrocarbon monitoring may be used separately or in combination. In an embodiment, overspeed detection may be based only on RPM or on RPM monitoring.

In alternative embodiments, some or all connections and cables and components in the apparatus, including but not limited to regulator/monitor cable 40 and transmitter/receiver cables 150 and 152 may optionally comprise or have associated therewith, anti-tamper assemblies so that should tampering occur, the monitor 36 or regulator 8 will initiate a shutdown sequence. In embodiments, the operation of the valve 10 is directly controlled (both closing and opening) via the microprocessor 60 comprised in the valve controller 34 under the direction of the monitor 36 which may be activated by signals from the controller 12, or from the emergency stop switch 24, or in response to data from one or more sensors such as 30, 28, 32, 41. It will be appreciated that in embodiments certain sensors and connections may be integral to other parts of the apparatus including the valve 10, the valve motor 62 and their associated structures.

In alternative embodiments, the first controller may also transmit a permission signal to the regulator and the movement of the valve into the one of the positions may be reversible in response to or following receipt of the permission signal from the first controller. In further alternative embodiments, the apparatus may further comprise a plurality of assets and the individual ones of the assets may be independently remotely and controllably deactivateable or partly deactivateable. In yet further alternative embodiments, the valve 10 may have an associated valve position sensor 28 and the status information 15 may include information regarding the valve position.

In alternative embodiments, there is disclosed a method for remotely controllably deactivating or partly deactivating a first asset 4. The first asset may comprise an air dependent power source 6 having an air supply and the method may comprise providing a regulator 8 associated with the first asset 4, comprising a valve 10 having first and second positions wherein the first position allows a first rate of the air supply to the power source and the second position allows a second rate of the air supply to the power source and wherein the second rate is less than the first rate. The method may comprise providing a controller remote from the regulator, for transmitting a control signal 14 to the regulator 8; the valve 10 being actuable in response to the control signal 14 to move between the first and second positions thereby regulating the air supply to the power source 6. In alternative embodiments, the method may comprise providing a second controller 22 and the valve 10 may have a plurality of positions between the first and second positions and may be actuable in response to a signal from the second controller 22 to move into a selected one of the positions to at least partly limit the air supply to the power source 6. In an embodiment this shutdown may be complete and the closure may prevent substantially all flow of air to power source 6. In alternative embodiments, the regulator 8 may comprise a hydrocarbon detector 30 and be adapted to deactivate the power source 6 when information from the hydrocarbon detector 30 satisfies predetermined parameters.

In alternative embodiments, there is disclosed an apparatus for controllably deactivating, or partly deactivating, a first asset 4, in response to a control signal 14 from a remote controller 12, the first asset comprising an air dependent power source 6 having an air supply. The apparatus may comprise: a regulator 8 associated with the first asset and comprising a valve 10 having first and second positions wherein the first position allows a first rate of the air supply to the power source and the second position allows a second rate of the air supply to the power source 6 and wherein the second rate is less than the first rate. The valve may be actuable by the regulator 8 in response to a control signal 14 from the controller 12 to move between the first and second positions so that the apparatus control signal 14. In alternative embodiments, the apparatus may comprise a transmitter for transmitting asset status information 15 to the control center.

In alternative embodiments, the valve 10 may have a plurality of alternate positions between the first and second positions and may be actuable in response to a signal from the controller 12 to adopt successive ones of the positions to incrementally regulate the air supply. In further alternative embodiments, the apparatus may comprise a second controller 22 and the valve 10 may be actuable in response to a signal from the second controller 22 to move into a selected one of the positions to at least partly limit the air supply to the power source 6.

In alternative embodiments, the apparatus may be constructed using a kit, the kit comprising suitable components to construct at least a part of the regulator and instructions to use the components to construct at least a part of the regulator.

The embodiments and examples presented herein are illustrative of the general nature of the subject matter claimed and are not limiting. It will be understood by those skilled in the art how these embodiments can be readily modified and/or adapted for various applications and in various ways without departing from the spirit and scope of the subject matter disclosed and claimed. The claims hereof are to be understood to include without limitation all alternative embodiments and equivalents of the subject matter hereof. Phrases, words and terms employed herein are illustrative and are not limiting. Where permissible by law, all references cited herein are incorporated by reference in their entirety. It will be appreciated that any aspects of the different embodiments disclosed herein may be combined in a range of possible alternative embodiments, and alternative combinations of features, all of which varied combinations of features are to be understood to form a part of the subject matter claimed.

We claim:

1. An apparatus for remotely controllably deactivating or partly deactivating a first asset, said first asset comprising an air dependent power source having an air supply and said apparatus comprising:
(a) a regulator associated with said first asset and comprising a valve having first and second positions wherein said first position allows a first rate of said air supply to said power source and said second position allows a second rate of said air supply to said power source and wherein said second rate is less than said first rate; and
(b) a controller remote from said regulator, for transmitting a control signal to said regulator;
said valve being actuable in response to said control signal to move between said first and second positions thereby regulating said air supply to said power source.

2. The apparatus according to claim 1 wherein said controller is comprised in a control center, and said regulator comprises a transmitter for transmitting asset status information to said control center.

3. The apparatus according to claim 2 wherein said valve has a plurality of alternate positions between said first and second positions and is actuable to adopt successive ones of said positions to incrementally regulate said air supply.

4. The apparatus according to claim 2 wherein said apparatus comprises a second controller and said valve is actuable in response to a signal from said second controller to move into a selected one of said positions to at least partly limit said air supply to said power source.

5. The apparatus according to claim 4 wherein said first controller is also for transmitting a permission signal to said regulator and said movement of said valve into said one of said positions is reversible in response to said permission signal from said first controller.

6. The apparatus as recited in claim 2, further comprising a plurality of said assets and wherein said individual ones of said assets are independently remotely controllably deactivateable or partly deactivateable.

7. The apparatus according to claim 2 wherein said valve has an associated valve position sensor and said status information includes information regarding said valve positions.

8. The apparatus according to claim 1 wherein said regulator comprises a hydrocarbon detector and is adapted to deactivate said power source when information from said sniffer satisfies predetermined parameters.

9. The apparatus according to claim 2 wherein said asset status information comprises asset positional information.

10. The apparatus according to claim 2 wherein said asset is a motor vehicle.

11. The apparatus as recited in claim 10, wherein said asset is a commercial vehicle and said regulator comprises a substantially tamper proof housing.

12. The apparatus as recited in claim 2, wherein said asset status information is selected from the group consisting of:
(a) the make and model of the asset;
(b) the owner of the asset;
(c) the place of registration of the asset;
(d) insurance information about the asset; and
(e) the attachment of any trailer to the asset.

13. The apparatus according to claim 4 wherein at least one of:
(a) said control signal; and
(b) said permission signal is encrypted.

14. A method for remotely controllably deactivating or partly deactivating a first asset, said first asset comprising an air dependent power source having an air supply and said method comprising:
(a) providing a regulator associated with said first asset and comprising a valve having first and second positions wherein said first position allows a first rate of said air supply to said power source and said second position allows a second rate of said air supply to said power source and wherein said second rate is less than said first rate; and
(b) providing a controller remote from said regulator, for transmitting a control signal to said regulator;
said valve being actuable in response to said control signal to move between said first and second positions thereby regulating said air supply to said power source.

15. The method according to claim 14 wherein said method comprises providing a second controller and said valve is actuable in response to a signal from said second controller to move into a selected one of said positions to at least partly limit said air supply to said power source.

16. The method according to claim 15 wherein said regulator comprises a hydrocarbon detector and is adapted to deactivate said power source when information from said hydrocarbon detector satisfies predetermined parameters.

17. An apparatus for controllably deactivating, or partly deactivating, an asset, in response to a control signal from a remote controller, said asset comprising an air dependent power source having an air supply and said apparatus comprising a regulator associated with said asset and comprising a valve having first and second positions wherein said first position allows a first rate of said air supply to said power source and said second position allows a second rate of said air supply to said power source and wherein said second rate is less than said first rate, said valve being actuable by said regulator in response to a control signal from the controller to move between said first and second positions so that said apparatus is useable to deactivate or partly deactivate said asset in response to a said control signal.

18. The apparatus according to claim 17 wherein said apparatus comprises a transmitter for transmitting asset status information to said control center.

19. The apparatus according to claim 18 wherein said valve has a plurality of alternate positions between said first and second positions and is actuable in response to a signal from the controller to adopt successive ones of said positions to incrementally regulate said air supply.

20. The apparatus according to claim 18 wherein said apparatus comprises a second controller and said valve is actuable in response to a signal from said second controller to move into a selected one of said positions to at least partly limit said air supply to said power source.

21. The apparatus according to claim 20 wherein said regulator comprises a hydrocarbon detector and is adapted to deactivate said power source when information from said hydrocarbon detector satisfies predetermined parameters.

22. The apparatus according to claim 20 wherein said asset is a motor vehicle.

23. The apparatus as recited in claim 22, wherein said asset is a commercial vehicle and said regulator comprises a substantially tamper-proof housing

24. A kit for making the apparatus according to claim 18, said kit comprising:
(a) suitable components to construct at least a part of said regulator; and
(b) instructions to use said components to construct at least a part of said regulator.

25. The apparatus according to claim 20 wherein said at least partial limiting of said air supply is substantially complete.
